(19) United States
(12) Patent Application Publication
(10) Pub. No.: US 2023/0226942 A1
(43) Pub. Date: Jul. 20, 2023

(54) CHARGING CONTROL DEVICE, AND INFORMATION PROCESSING METHOD

(71) Applicant: PANASONIC INTELLECTUAL PROPERTY MANAGEMENT CO., LTD, Osaka (JP)

(72) Inventors: Changhui YANG, Osaka (JP); Zhen HUANG, Kanagawa (JP); Takashi MATSUDA, Osaka (JP); Takashi IIDA, Hyogo (JP)

(21) Appl. No.: 18/002,425

(22) PCT Filed: Jun. 23, 2021
(86) PCT No.: PCT/JP2021/023734

§ 371 Date: Dec. 19, 2022

(30) Foreign Application Priority Data
Jul. 9, 2020 (JP) 2020-118146
Jan. 8, 2021 (JP) 2021-002133

(51) Int. Cl. B60L 53/66; B60L 53/68; B60L 53/62

(52) U.S. Cl. CPC B60L 53/66; B60L 53/68; B60L 53/62; B60L 2200/36

(57) ABSTRACT

A charge control device includes: a first communication section configured to: receive first data from a plurality of mobile vehicles respectively and transmit second data to the mobile vehicles respectively via first connection parts; and receive a third datum from a charger and transmit a fourth datum to the charger via a second connection part; and a control part that generates the fourth datum from the first data, generates the second data for the mobile vehicles respectively from the third datum received from the charger in response to the fourth datum, and causes the first communication section to transmit the fourth datum and the second data, each of the first data, the second data, the third datum, and the fourth datum complying with a charging standard.

### CROSS-REFERENCE TO RELATED APPLICATIONS

This application is the U.S. National Phase under 35 U.S.C. § 371 of International Patent Application No. PCT/JP2021/023734, filed on Jun. 23, 2021 which in turn claims the benefit of Japanese Patent Application No. 2020-118146, filed on Jul. 9, 2020, and Japanese Patent Application No. 2021-002133, filed on Jan. 8, 2021, the entire disclosures of which Applications are incorporated by reference herein.

### TECHNICAL FIELD

This disclosure relates to a technology of charging a plurality of mobile vehicles.

### BACKGROUND ART

Various technologies of charging a plurality of electric vehicles at the same time have been recently proposed along with the spread of electric vehicles. For instance, Patent Literature 1 discloses a charger including a plurality of connectors connectable to a plurality of electric vehicles each having a driving battery and an auxiliary battery. The charger sequentially charges the electric vehicles until a value of a charging electric current including that from the auxiliary battery for each of the electric vehicles reaches a threshold representing a fully-charged state of the driving battery, and thereafter charges the electric vehicles at the same time.

Patent Literature 2 discloses a charging station including: a plurality of connectors; a normal-speed charger for charging a plurality of electric vehicles connectable to one another via the connectors at the same time; and a high-speed charger for sequentially charging the electric vehicles at a high speed by switching the electric vehicles thereamong.

However, in each of Patent Literatures 1 and 2, the charger needs to include a plurality of connectors. Therefore, the technology disclosed in each of Patent Literatures 1 and 2 is unapplicable to a charger including only a single connector.

### CITATION LIST

### Patent Literature

Patent Literature 1: Japanese Unexamined Patent Publication No. 2018-85889
Patent Literature 2: Japanese Unexamined Patent Publication No. 2014-176232

### SUMMARY OF INVENTION

This disclosure has an object of providing a charge control device and an information processing method for permitting a charger including a single charging connector to charge a plurality of mobile vehicles in accordance with a charging standard.

A charge control device according to an aspect of this disclosure includes: a plurality of first connection parts respectively connectable to a plurality of mobile vehicles each having a battery; a second connection part connectable to a charger; and a first communication section configured to: (1) receive first data from the mobile vehicles respectively and transmit second data to the mobile vehicles respectively via the first connection parts; and (2) receive a third datum from the charger and transmit a fourth datum to the charger via the second connection part, each of the first data, the second data, the third datum, and the fourth datum complying with a charging standard; and a control part that generates the fourth datum from the first data, generates the second data for the mobile vehicles respectively from the third datum received from the charger in response to the fourth datum, and causes the first communication section to transmit the fourth datum and the second data.

This disclosure permits a charger including a single charging connector to charge a plurality of mobile vehicles in accordance with a charging standard.

### BRIEF DESCRIPTION OF DRAWINGS

FIG. 1 shows an overall configuration of a charging system in a first embodiment of the disclosure.

FIG. 2 is a block diagram showing a configuration of a charge control device shown in FIG. 1.

FIG. 3 is a block diagram showing a configuration of a mobile vehicle shown in FIG. 1.

FIG. 4 is a block diagram showing a configuration of a charger shown in FIG. 1.

FIG. 5 is a block diagram showing a configuration of a server.

FIG. 6 shows an example of a data configuration of each of battery information and pseudo-battery information.

FIG. 7 shows an example of a data configuration of each of charger information and pseudo-charger information.

FIG. 8 shows an example of a data configuration of a charging schedule.

FIG. 9 is a sequence diagram showing an example of a process by the charging system shown in FIG. 1.

FIG. 10 shows an overall configuration of a charging system in a second embodiment of the disclosure.

FIG. 11 is a block diagram showing a configuration of a charge control device shown in FIG. 10.

FIG. 12 is a block diagram showing a configuration of a mobile vehicle shown in FIG. 10.

### DESCRIPTION OF EMBODIMENTS

Hereinafter, the embodiments of this disclosure will be described with reference to the accompanying drawings. It should be noted that each of the following embodiments illustrates one specific example of this disclosure, and does not delimit the protection scope of this disclosure.

Circumstances LED Up to this Disclosure

The present inventors have studied for applying an already-existing charger widely spreading on the market to a charger for a cooperative use, such as a transport company owning a plurality of vehicles. For instance, at a collection and delivery station of a transport company, a single charger is required to charge a plurality of mobile vehicles at the same time or in appropriate order so that the mobile vehicles are charged in a limited time period from a service finish time to a service start time. For example, it is necessary to actively change the charging order in accordance with a change in an operational time of each mobile vehicle.

However, an already-existing charger basically includes a single charging connector in many cases. Besides, the already-existing charger communicates with a mobile vehicle in accordance with a predetermined charging standard when charging the mobile vehicle. The charging standard is defined on the premise that one mobile vehicle is connected to one charger. Therefore, a plurality of charging connectors and further a change in the charging standard of the already-existing charger for communication with a plurality of mobile vehicles are demanded to charge the mobile vehicles at the same time in use of the already-existing charger. However, it is difficult to change the charging standard. Moreover, for the purpose of charging a plurality of mobile vehicles in appropriate order by employing the already-existing charger, switching of connection among the mobile vehicles is required in accordance with the charging order. However, if such switching is performed by a person, a human labor and a relevant labor cost would increase.

This disclosure has been achieved to solve the drawbacks described above, and has an object of providing a technology of permitting an already-existing charger to charge a plurality of mobile vehicles in accordance with a charging standard.

A charge control device according to an aspect of this disclosure includes: a plurality of first connection parts respectively connectable to a plurality of mobile vehicles each having a battery; a second connection part connectable to a charger; and a first communication section configured to: (1) receive first data from the mobile vehicles respectively and transmit second data to the mobile vehicles respectively via the first connection parts; and (2) receive a third datum from the charger and transmit a fourth datum to the charger via the second connection part, each of the first data, the second data, the third datum, and the fourth datum complying with a charging standard; and a control part that generates the fourth datum from the first data, generates the second data for the mobile vehicles respectively from the third datum received from the charger in response to the fourth datum, and causes the first communication section to transmit the fourth datum and the second data.

According to this configuration, the charge control device includes: the first connection parts respectively connectable to the mobile vehicles; and the second connection part connectable to the single charger. The charge control device having this configuration achieves a physical connection between the single charger and the mobile vehicles. Besides, the charge control device generates the fourth datum from the first data transmitted from the mobile vehicles respectively and transmits the generated fourth datum to the charger, and further generates the second data for the mobile vehicles respectively from the third datum received from the charger in response to the fourth datum and transmits the generated second data to the mobile vehicles respectively. Here, each of the first data to the fourth datum complies with a predetermined charging standard. This configuration allows the already-existing charger to communicate with the mobile vehicles without changing the charging standard. This consequently permits the charger including the single charging connector to charge the mobile vehicles in accordance with the charging standard.

The charge control device may further include a second communication section that transmits the first data to an external device and receives a charging schedule for each of the mobile vehicles from the external device. The charging to each of the mobile vehicles may be controlled in accordance with the charging schedule.

According to this configuration, charging to each of the mobile vehicles is controlled in accordance with the charging schedule received from the external device in response to the first data of the mobile vehicles respectively transmitted to the external device. In this manner, each mobile vehicle is chargeable in accordance with the charging schedule suitable for each mobile vehicle by employing the already-existing charger.

In the charge control device, each of the first data and the fourth datum may include a state of the battery, each of the second data and the third datum may include an output way of the charger, the state of the battery included in the fourth datum may be generated by calculation of or comparison with the state of the battery included in each of the first data, and each output way included in the second data may be generated by distributing the output way included in the third datum to each of the mobile vehicles.

According to this configuration, the state of the battery included in the fourth datum is generated by calculation of or comparison with the state of the battery included in each of the first data, and is transmitted to the charger. Hence, the charger is notified of the state of the battery as if a single mobile vehicle was connected thereto. Besides, the second data is generated by distributing the output way included in the third datum received from the charger to each of the mobile vehicles, and the generated second data is transmitted to the mobile vehicles respectively. Therefore, the output state of the charger can be individually notified to each mobile vehicle. This results in easy achievement of charging the mobile vehicles at the same time without changing the already-existing configuration and charging standard of the charger.

In the charge control device, each of the first data and the fourth datum may further include a specification of the battery of each of the mobile vehicles, the second communication section may further transmit, to the external device, the specification and the state of the battery of each of the mobile vehicles, and a plurality of generated output ways of the charger as a plurality of pseudo-output ways, and the received charging schedule may be based on the transmitted specification and state of the battery of each of the mobile vehicles, and based on the generated pseudo-output ways of the charger.

According to this configuration, the charging schedule more suitable for each of the mobile vehicles is generatable on the basis of the specification and the state of the battery of each mobile vehicle and a plurality of pseudo-output ways. Further, the charging schedule is generatable by employing already-existing charging schedule processing through an input of a pseudo-charger (i.e., virtual charger) to the charging schedule.

The charge control device may further include: a second communication section that receives a charging schedule for each of the mobile vehicles from an external device. The fourth datum may be generated from the first data in accordance with the charging schedule.

According to this configuration, the fourth datum is generated from the first data and the generated fourth datum is transmitted to the charger in accordance with the charging schedule received from the external device, and therefore, each mobile vehicle is chargeable in accordance with the charging schedule.

In the charge control device, each of the first data and the fourth datum may include a charging request, each of the second data and the third datum may include an output state of the charger, the charging request included in the fourth datum may be generated on the basis of at least one of the charging request included in the first data and the charging schedule for each of the mobile vehicles to be charged at the same time in accordance with the charging schedule, and each output state included in the second data may be generated by distributing the output state included in the third datum to each of the mobile vehicles.

According to this configuration, the charging request included in the fourth data is generated on the basis of at least one of the charging request included in the first data and the charging schedule for each of the mobile vehicles, and is transmitted to the charger. Hence, the charger is notified of the charging request as if a single mobile vehicle was connected thereto. Besides, the second data is generated by distributing the output state included in the third datum received from the charger to each of the mobile vehicles, and the generated second data is transmitted to the mobile vehicles respectively. Therefore, the output state of the charger can be individually notified to each mobile vehicle. This results in easy achievement of charging the mobile vehicles at the same time without changing the already-existing configuration and charging standard of the charger.

In the charge control device, an electric current output from the charger in accordance with each output state included in the second output data may be distributed to each of the mobile vehicles.

According to this configuration, the electric current output from the charger is distributed to the mobile vehicles respectively in accordance with each output state included in the second data, and thus, the electric current for each of the mobile vehicles is determined in consideration of the output state for each mobile vehicle. Consequently, each mobile vehicle is chargeable with the electric current suitable for each mobile vehicle.

An information processing method according to another aspect of this disclosure relates to an information processing method for a charge control device for charging a plurality of mobile vehicles each having a battery. The charge control device includes: a plurality of first connection parts respectively connectable to the mobile vehicles; and a second connection part connectable to a charger. The method includes, by a computer: receiving first data from the mobile vehicles respectively via the first connection parts; generating a fourth datum from the first data; transmitting the fourth datum to the charger via the second connection part; receiving a third datum from the charger in response to the fourth datum; generating second data for the mobile vehicles respectively from the third datum; and transmitting the second data to the charger via the first connection parts, each of the first data, the second data, the third datum, and the fourth datum complying with a charging standard.

According to this configuration, the charge control device includes: the first connection parts respectively connectable to the mobile vehicles; and the second connection part connectable to the single charger. The charge control device having this configuration achieves a physical connection between the single charger and the mobile vehicles. Besides, the charge control device generates the fourth datum from the first data transmitted from the mobile vehicles respectively and transmits the generated fourth datum to the charger, and further generates the second data for the mobile vehicles respectively from the third datum received from the charger in response to the fourth datum and transmits the generated second data to the mobile vehicles respectively. Here, each of the first data to the fourth datum complies with a predetermined charging standard. This configuration allows the already-existing charger to communicate with the mobile vehicles without changing the charging standard. This consequently permits the charger including the single charging connector to charge the mobile vehicles in accordance with the charging standard.

A charge control device according to further another aspect of the disclosure includes: a plurality of first connection parts respectively connectable to a plurality of mobile vehicles each having a battery; a second connection part connectable to a charger; and a first communication section configured to: (1) receive first data from the mobile vehicles respectively and transmit second data to the mobile vehicles respectively via the first connection parts, the first data including a state of the battery, the second data including an output way of the charger; and (2) receive a third datum from the charger and transmit a fourth datum to the charger via the second connection part, the third datum including the output way, the fourth datum including the state of the battery; a control part that generates the fourth datum from the first data, generates the second data for the mobile vehicles respectively from the third datum received from the charger in response to the fourth datum, and causes the first communication section to transmit the fourth datum and the second data. The first communication section is further configured to: (3) receive fifth data from the mobile vehicles respectively and transmit sixth data to the mobile vehicles respectively via the first connection parts, each of the fifth data including a charging request, each of the sixth data including an output state of the charger; and (4) receive a seventh datum from the charger and transmit an eighth datum to the charger via the second connection part, the seventh datum including the output state, the eighth datum including the charging request. The charging request included in the eighth datum is generated on the basis of at least one of a charging schedule and the charging request included in each of the fifth data for each of the mobile vehicles to be charged at the same time in accordance with the charging schedule. Each output state included in the sixth data is generated by distributing the output state included in the seventh datum to each of the mobile vehicles. Each of the first data, the second data, the third datum, the fourth datum, the fifth data, the sixth data, the seventh datum, and the eighth datum complies with a charging standard.

According to this configuration, a communication connection is established among the charge control device, the mobile vehicle, and the charger through transfer of the first data to the fourth datum, and thus the charge control device can distribute the electric power supplied from the charger to the mobile vehicles through transfer of the fifth data to the eighth datum. This consequently permits the charger including the single charging connector to charge the mobile vehicles in accordance with the charging standard.

This disclosure can be realized as a program for causing a computer to execute each distinctive feature included in such a charge control device. Additionally, it goes without saying that the computer program is distributable as a non-transitory computer readable storage medium like a CD-ROM, or distributable via a communication network like the Internet.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### First Embodiment

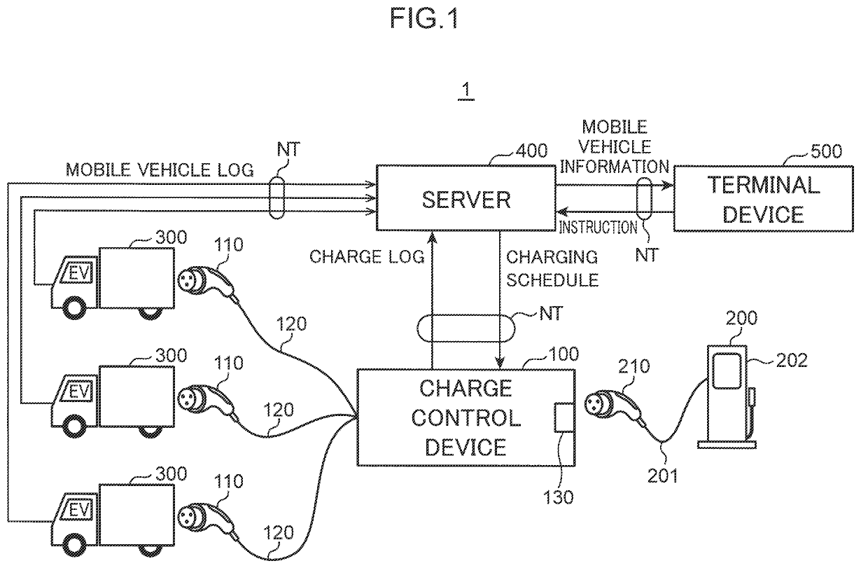

FIG. 1 shows an overall configuration of a charging system 1 in a first embodiment of the disclosure. The charging system 1 is a system for charging a mobile vehicle 300 administrated at, for example, a collection and delivery station of a transport company. The charging system 1 includes a charge control device 100, a charger 200, a mobile vehicle 300, a server 400, and a terminal device 500.

The charge control device 100 is called a charging adapter as well, and is connectable to the charger 200 and the mobile vehicle 300 therebetween when the charger 200 charges the mobile vehicle 300. The charge control device 100 includes operability of distributing electric power from the charger 200 to a plurality of mobile vehicles 300. With this operability, the charger 200 configured to charge a single mobile vehicle 300 also can charge a plurality of mobile vehicles 300 at the same time without changing the already-existing configuration thereof.

The charge control device 100 includes N-first connection parts 110, where “N” is a natural number equal to or greater than 2, and a single second connection part 130. The charge control device 100 is connectable to N-mobile vehicles 300 via the N-first connection parts 110. Here, the number of the first connection parts may be one, i.e., N=1.

Each of the first connection parts 110 includes a charging connector complying with a charging standard of each mobile vehicle 300, and is physically connectable to the mobile vehicle 300 via a charging cable 120. The first connection part 110 has a communication terminal and an electric power terminal. The communication terminal allows the charge control device 100 to communicate with the mobile vehicle 300. The electric power terminal allows the charge control device 100 to supply the electric power to the mobile vehicle 300.

N-charging cables 120 correspond to the N-first connection parts 110. Each of the charging cables 120 has a communication line and an electric power line. The communication line aims at transferring a communication signal between the charge control device 100 and the mobile vehicle 300. The electric power line aims at supplying the electric power from the charge control device 100 to the mobile vehicle 300. Each of the communication terminal and the communication line of the first connection part 110 complies with a communication standard of a predetermined in-vehicle network. Adoptable examples of the predetermined in-vehicle network include the CAN (Controller Area Network).

The second connection part 130 includes a charge port complying with a standard of the charger 200, and is physically connectable to a charging connector 210 via a charging cable 201. The second connection part 130 has a communication terminal and an electric power terminal. The communication terminal allows the charge control device 100 to communicate with the charger 200. The electric power terminal allows the charge control device 100 to receive the electric power from the charger 200.

The charger 200 is called a charging pole as well, and represents an already-existing charger 200 widely spreading on the market. The charger 200 includes the single charging connector 210, the single charging cable 201, and a main body 202. The charging connector 210 has a communication terminal and an electric power terminal. The communication terminal allows the charger 200 to communicate with the charge control device 100. The electric power terminal allows the charger 200 to supply the electric power to the charge control device 100.

The charging cable 201 has a communication line and an electric power line. The communication line aims at transferring a communication signal between the charger 200 and the charge control device 100. The electric power line aims at supplying the electric power from the charger 200 to the charge control device 100.

Examples of the mobile vehicle 300 include an electric vehicle. The electric vehicle is, for example, a delivery truck for delivering an article. Examples of the electric vehicle may include a plug-in hybrid automobile, in addition to an electric vehicle driven with only electric power in a narrow sense. Besides, a replaceable battery pack vehicle configured in such a manner that a battery pack mounted on the vehicle is replaceable with another new one is also known as the electric vehicle. The electric vehicle of this type may have a configuration where the battery pack in a state of being detached from the vehicle body is charged. The mobile vehicle 300 may include the battery pack mounted on the replaceable battery pack vehicle. In this case, the battery pack in the state of being detached from the replaceable battery pack vehicle is connected to the charging cable 120.

The server 400 is connected to the charge control device 100, each mobile vehicle 300, and the terminal device 500 via a network NT. The network NT includes, for example, a wide area network having the internet. The server 400 receives a mobile vehicle log including a state of each mobile vehicle 300 from each mobile vehicle 300. The server 400 receives, from the charge control device 100, a charge log including a charged state of each mobile vehicle 300 in the charging, and transmits a charging schedule for each mobile vehicle 300 to the charge control device 100.

The mobile vehicle log contains information about charging to each mobile vehicle 300 and information about completion of the charging. Further, the mobile vehicle log contains a discharging start time, a discharging completion time, a discharging electric current, a discharging voltage, and a time shift of an SOC in the discharging. The charge log contains a charging start time and a charging completion time. The charge log further contains a time shift of each of an SOC, a charging electric current, and a charging voltage from the charring start to the charring completion.

The server 400 further receives an instruction transmitted from the terminal device 500 and transmits mobile vehicle information to the terminal device 500. The mobile vehicle information includes information indicating a normal state of the mobile vehicle 300, information indicating an abnormal state of the mobile vehicle 300, and information indicating completion of the charging to the mobile vehicle 300. The instruction includes a compulsory stop of the charging by a manager. The instruction further includes an input of a delivery schedule for each mobile vehicle 300 by the manager.

The terminal device 500 includes a computer owned by the manager of each mobile vehicle 300. The computer may include, for example, a stationary computer, or may include a tablet terminal or a mobile terminal, such as a smartphone. The terminal device 500 acquires the delivery schedule input by the manager. The terminal device 500 causes an unillustrated display to display information about a current state of each mobile vehicle 300 and abnormality or normality thereof in accordance with the mobile vehicle information about each mobile vehicle 300 as transmitted from the server 400.

In the charging system 1, the charge control device 100 and the charger 200 are located at, for example, the collection and delivery station. The server 400 is located on the cloud.

Here, in FIG. 1, the charging system 1 is adapted to charging to the mobile vehicle 300 at the collection and delivery station, but this is a mere example. The charging system 1 may be adapted to charging to an electrically driven cart on a golf course. In this case, the electrically driven cart is adoptable as the mobile vehicle 300. Furthermore, the charging system 1 may be provided in a service offering place of a route-bus company, a sightseeing bus company, or a taxi company. In this case, the mobile vehicle 300 includes a bus or a taxi of an electric type. Moreover, the mobile vehicle 300 may include a motorbike, an electric bicycle, and an electric kicking board.

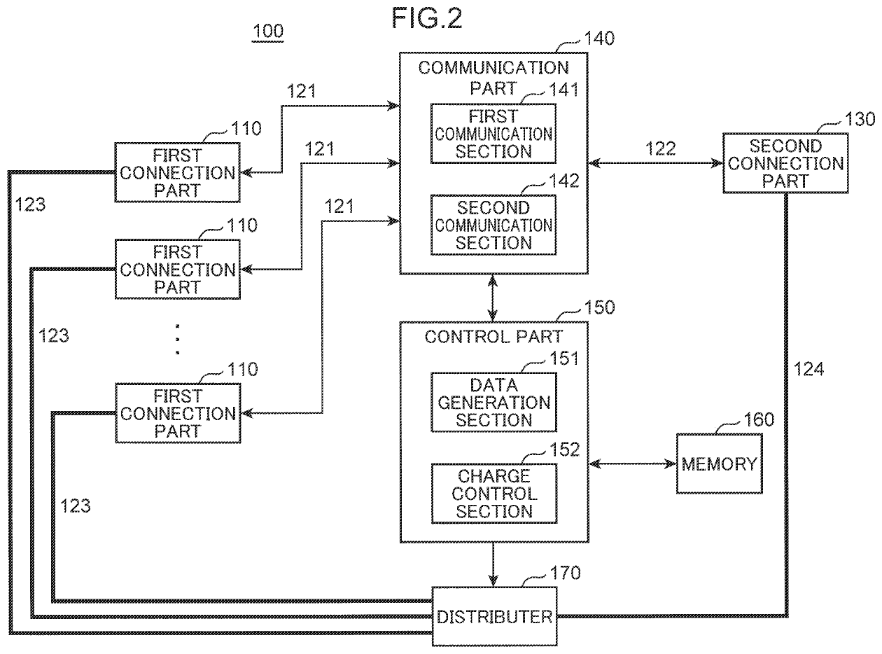

Heretofore, the overall configuration of the charging system 1 has been described. Next, the charging system 1 will be described in detail. FIG. 2 is a block diagram showing a configuration of the charge control device 100 shown in FIG. 1. The charge control device 100 includes a communication part 140, a control part 150, a memory 160, and a distributer 170, in addition to the N-first connection parts 110 and the single second connection part 130 shown in FIG. 1. Each of the N-first connection parts 110 and the communication part 140 are connected to each other via a communication line 121. The second connection part 130 and the communication part 140 are connected to each other via a communication line 122. The communication part 140, the control part 150, and the memory 160 are connected to one another via bus lines.

Each of the N-first connection parts 110 and the distributer 170 are parallelly connected to each other via an electric power line 123. The second connection part 130 and the distributer 170 are connected to each other via an electric power line 124.

The communication part 140 has a first communication section 141 and a second communication section 142. The first communication section 141 includes a communication circuit for allowing the charge control device 100 to communicate with the mobile vehicle 300 and the charger 200. The first communication section 141 receives first data from the N-mobile vehicles 300 respectively via the first connection parts 110. The first communication section 141 transmits second data to the mobile vehicles 300 respectively. Furthermore, the first communication section 141 receives a third datum from the charger 200 and transmits a fourth datum to the charger 200 via the second connection part 130.

Each of the first data, the second data, the third datum, and the fourth datum complies with a predetermined charging standard. Adoptable examples of the predetermined standard include the CHAdeMO and the GB/T.

The second communication section 142 includes a communication circuit for connecting the charge control device 100 to the network NT. The second communication section 142 transmits the first data transmitted from the mobile vehicles 300 respectively to the server 400 (which is an example of the external device). The second communication section 142 further receives a charging schedule for each of the mobile vehicles 300 from the server 400.

The control part 150 includes, for example, a processor, such as a CPU, and controls the entirety of the charge control device 100. The control part 150 has a data generation section 151 and a charge control section 152. Each of the data generation section 151 and the charge control section 152 comes into effect, for example, when a processor executes a program for causing a computer to serve as the charge control device 100.

The data generation section 151 acquires the first data transmitted from the mobile vehicles 300 respectively via the first communication section 141, and generates the fourth datum from the acquired first data. The data generation section 151 transmits the generated fourth datum to the charger 200 via the first communication section 141.

The data generation section 151 generates second data for the mobile vehicles 300 respectively from a third datum received from the charger 200 via the first communication section 141 in response to the fourth datum. The data generation section 151 transmits the generated second data to the mobile vehicles 300 respectively via the first communication section 141.

In the first embodiment, a process by the charge control device 100 is mainly divided into a communication establishment phase and a charging phase.

The communication establishment phase is aimed at establishing a communication connection between the charge control device 100 and each mobile vehicle 300, and a communication connection between the charge control device 100 and the charger 200. The charging phase is aimed at charging a battery 340 included in the mobile vehicle 300 after each communication connection is established in the communication establishment phase.

In the first embodiment, contents of the first data to the fourth datum differ between the communication establishment phase and the charging phase.

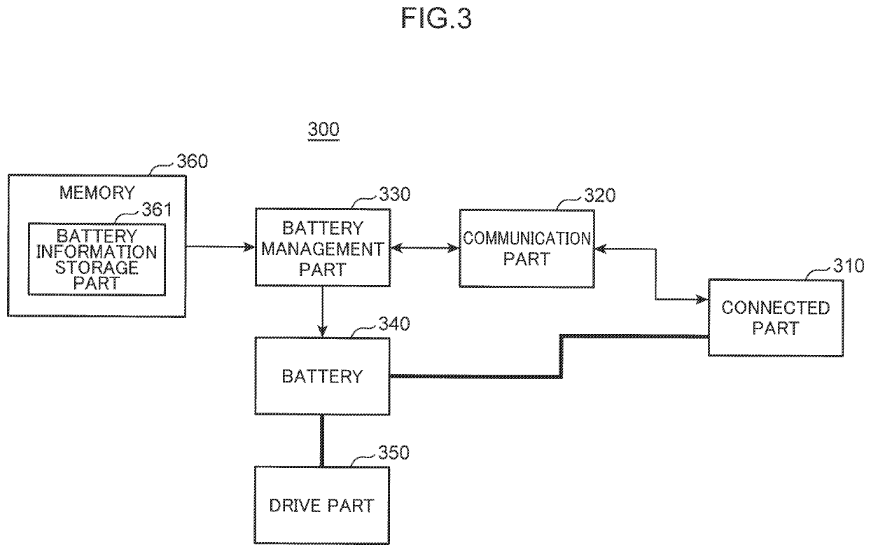

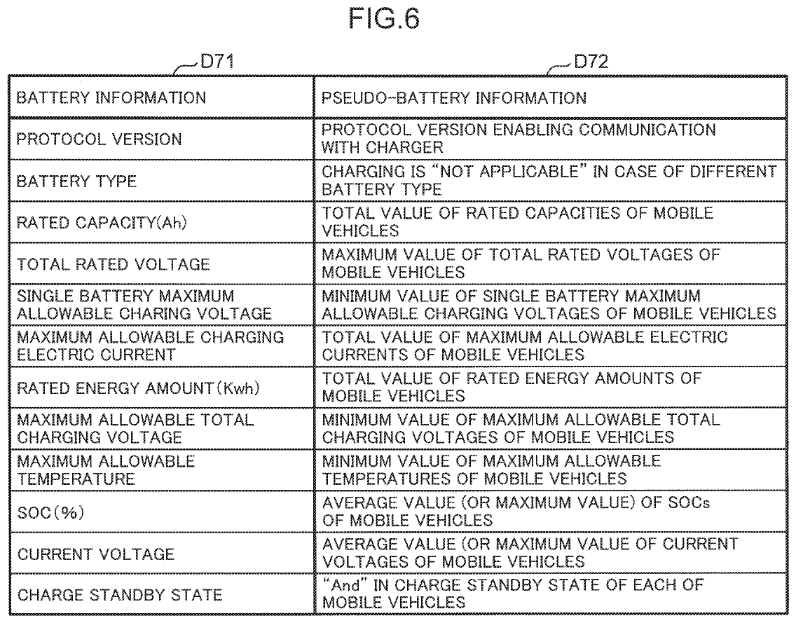

In the communication establishment phase, the first data corresponds to battery information D71 shown in FIG. 6. The battery information D71 represents information about a specification and a state of the battery 340 (see FIG. 3) mounted on the mobile vehicle 300.

In the communication establishment phase, the fourth datum corresponds to pseudo-battery information D72 shown in FIG. 6. The pseudo-battery information D72 is generated by calculation of or comparison with the battery information D71 about each of the mobile vehicles 300 for the single charger 200. The pseudo-battery information D72 represents information for causing the charger 200 to recognize the plurality of mobile vehicles 300 to be charged as a single mobile vehicle 300 in a pseudo-manner.

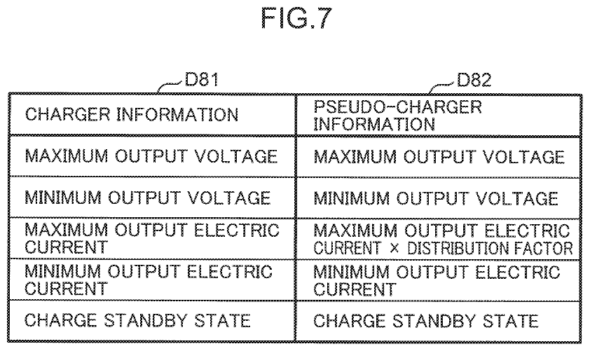

In the communication establishment phase, the third datum corresponds to charger information D81 shown in FIG. 7. The charger information D81 represents information about an output way of the charger 200. In the communication establishment phase, the second data corresponds to pseudo-charger information D82 shown in FIG. 7. The pseudo-charger information D82 is generated individually for each mobile vehicle 300 so that the electric power from the charger 200 is distributed to the mobile vehicles 300, and the information includes a pseudo-output way of the charger 200. The pseudo-charger information D82 represents information for causing each mobile vehicle 300 to recognize as if each mobile vehicle 300 was allotted its individual charger 200.

In the charging phase, each of the first data corresponds to a charging request from each mobile vehicle 300 to the charger 200. The charging request contains a charging request electric current of the battery 340. In the charging phase, the fourth datum corresponds to a pseudo-charging request. The pseudo-charging request represents information for causing the charger 200 to recognize charging requests from the mobile vehicles 300 to be charged as a single charging request from a single vehicle 300 in a pseudo-manner. The pseudo-charging request represents information generated on the basis of at least one of the charging schedule for each of the mobile vehicles 300 and the pseudo-charging request from each mobile vehicle 300, for the single charger 200. The pseudo-charging request contains a charging request voltage, a charging request electric current, and an SOC about a single pseudo-mobile vehicle 300.

In the charging phase, the third datum corresponds to an output state of the charger 200. The output state includes information about an output electric current and an output voltage of the charger 200, and further abnormality or normality of the charger 200. In the charging phase, each of the second data corresponds to a pseudo-output state of the charger 200. The pseudo-output state represents information generated individually for each of the mobile vehicles 300 to be charged so that the electric power from the charger 200 is distributed to the mobile vehicles 300, and the information includes a pseudo-output electric current and a pseudo-output voltage of the charger 200, and further abnormality or normality of the charger 200.

The charge control section 152 controls the distributer 170 to distribute the electric power supplied from the charger 200 via the second connection part 130 to the mobile vehicles 300 respectively.

The memory 160 includes a rewritable non-volatile storage device, e.g., flash memory, and stores various kinds of data.

The distributer 170 distributes the electric power supplied from the charger 200 via the second connection part 130 under the control by the charge control section 152. For instance, the distributer 170 may set a value of a charging electric current and a value of a charging voltage each supplied through each first connection part 110 in accordance with a control signal input from the charge control section 152, and distribute the electric power supplied through the second connection part 130.

FIG. 3 is a block diagram showing a configuration of the mobile vehicle 300 shown in FIG. 1. The mobile vehicle 300 includes a connected part 310, a communication part 320, a battery management part 330, the battery 340, a drive part 350, and a memory 360. In FIG. 3, a bold connection line indicates an electric power line, and a thin connection line indicates a signal line.

The connected part 310 is connectable to the corresponding first connection part 110. The connected part 310 is connected to the communication part 320 via a communication line and connected to the battery 340 via the electric power line.

The communication part 320 includes a communication circuit for connecting the mobile vehicle 300 to the network NT and a communication circuit for connecting the mobile vehicle 300 to the charge control device 100. The communication part 320 transmits the first data to the charge control device 100 and receives the second data from the charge control device 100 via the connected part 310. The communication part 320 transmits a mobile vehicle log to the server 400.

The battery management part 330 includes, for example, a processor, such as a CPU, and controls the entirety of the battery 340. For instance, the battery management part 330 measures a state of the battery 340. The state of the battery 340 includes an SOC, a charging electric current, a discharging electric current, a charging voltage, and a discharging voltage of the battery 340. The battery management part 330 may measure the state of the battery 340 at, for example, a predetermined sampling rate, and transmit a measurement result as the mobile vehicle log to the server 400 via the communication part 320. Moreover, the battery management part 330 may transmit the state of the battery 340 to the charge control device 100, for example, in response to a request from the charge control device 100.

The battery 340 includes a chargeable secondary battery like a lithium-ion battery. The battery 340 receives a supply of the electric power from the charger 200 via the connected part 310 to be charged with the electric power.

The drive part 350 includes an inverter and a motor. The inverter converts direct current power stored in the battery 340 into alternate current power to drive the motor. The motor drives a wheel of the mobile vehicle 300 with the electric power from the inverter.

The memory 360 includes a rewritable non-volatile storage device, e.g., flash memory. The memory 360 has a battery information storage part 361. The battery information storage part 361 stores the battery information D71 including the specification and the state of the battery 340.

Specifically, as shown in FIG. 6, the battery information D71 includes a protocol version, a battery type, a rated capacity (Ah), a total rated voltage, a single battery maximum allowable charging voltage, a maximum allowable charging electric current, a rated energy amount (Kwh), a maximum allowable total charging voltage, a maximum allowable temperature, an SOC (%), a current voltage, and a charge standby state.

The protocol version represents a version of a communication protocol for use in communication by the battery management part 330. When the communication protocol does not agree with a communication protocol of the charger 200, the mobile vehicle 300 fails to communicate with the charger 200.

The battery type represents information about a type of the battery 340, for example, a model thereof. When the battery type does not agree with a battery type allowing the charger 200 to perform charging, the battery 340 is not charged. The rated capacity represents a rated capacity of the battery 340. The total rated voltage represents a rated voltage of the entirety of the battery 340. The single battery maximum allowable charging voltage represents a maximum value of the allowable charging voltage of the entirety of the battery 340. The maximum allowable charging electric current represents a maximum value of an allowable charging electric current of the battery 340. The rated energy amount represents a rated energy amount of the battery 340. The maximum allowable total charging voltage represents a total value of the charging voltage of the entirety of the battery 340. The maximum allowable temperature represents a maximum value of an allowable temperature of the battery 340. The SOC represents a current SOC of the battery 340. The current voltage represents a current voltage of the battery 340. The charge standby state represents information indicating a chargeable state of the mobile vehicle 300. In FIG. 6, each of the SOC, the current voltage, and the charge standby state represents the state of the battery 340, and each of the remaining items represents the specification of the battery 340.

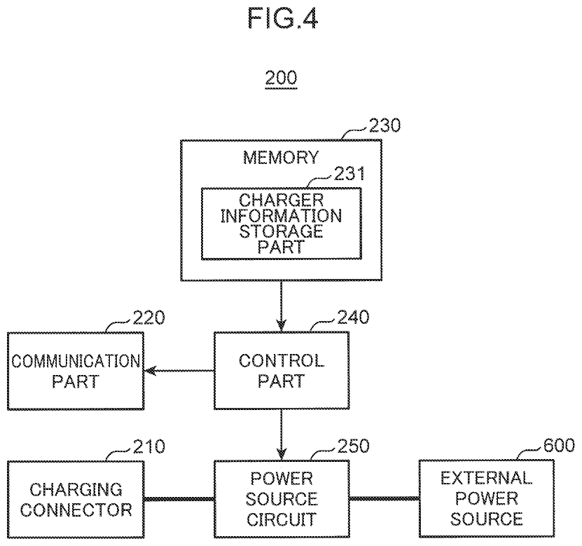

FIG. 4 is a block diagram showing a configuration of the charger 200 shown in FIG. 1. In FIG. 4, a bold connection line indicates an electric power line, and a thin connection line indicates a signal line. The charger 200 includes the charging connector 210, a communication part 220, a memory 230, a control part 240, and a power source circuit 250.

The charging connector 210 is connectable to the second connection part 130 of the charge control device 100. The communication part 220 includes a communication circuit for connecting the charger 200 to the charge control device 100. The communication part 220 receives a fourth datum transmitted from the charge control device 100. The communication part transmits a third datum to the charge control device 100 in response to the fourth datum.

The memory 230 includes a rewritable non-volatile storage device, e.g., flash memory. The memory 230 has a charger information storage part 231. The charger information storage part 231 stores the charger information D81 including an output way of the charger 200.

As shown in FIG. 7, the charger information D81 includes a maximum output voltage, a minimum output voltage, a maximum output electric current, a minimum output electric current, and a charge standby state. The maximum output voltage represents a maximum voltage which the charger 200 can output. The minimum output voltage represents a minimum voltage which the charger 200 can output. The maximum output electric current represents a maximum value of an electric current which the charger 200 can output. The minimum output electric current represents a minimum value of the electric current which the charger 200 can output. The charge standby state represents information indicating a chargeable state of the charger 200.

The control part 240 includes, for example, a processor, such as a CPU, and controls the entirety of the charger 200. When the communication part 220 receives the fourth datum, the control part 240 generates the third datum in response to the fourth datum, and transmits the generated third datum to the charge control device 100 via the communication part 220.

The power source circuit 250 includes, for example, a convertor to convert an alternate current of the electric power from an external power source 600 into a direct power to supply the converted electric power to the charging connector 210.

The external power source 600 includes, for example, a power source of an electricity company.

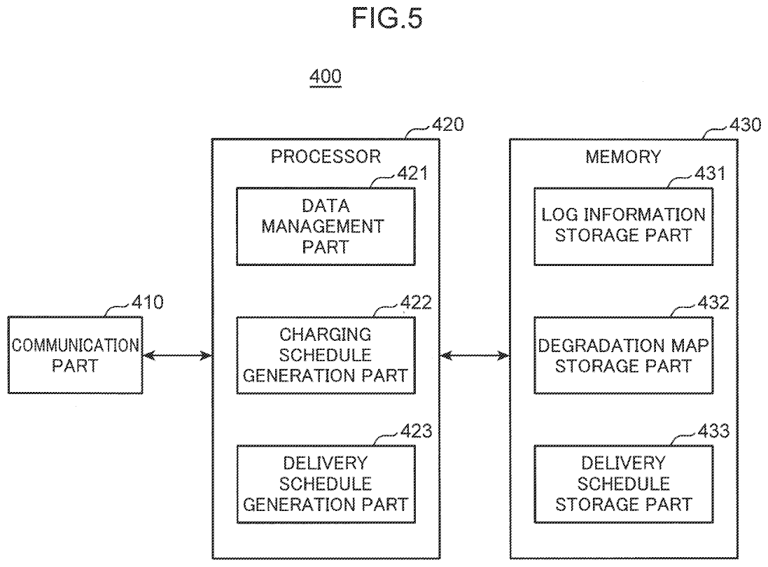

FIG. 5 is a block diagram showing a configuration of the server 400. The server 400 includes a communication part 410, a processor 420, and a memory 430. The communication part 410 includes a communication circuit for connecting the server 400 to the network NT. The processor 420 includes, for example, a CPU.

The communication part 410 receives a mobile vehicle log transmitted from each of the mobile vehicles 300. The communication part 410 receives a charge log transmitted from the charge control device 100. The communication part 410 receives battery information D71 about each mobile vehicle 300. The communication part 410 receives pseudo-charger information D82 transmitted from the charge control device 100. The communication part 410 transmits a charging schedule generated by a charging schedule generation part 422 to the charge control device 100.

The memory 430 includes a rewritable non-volatile storage device, such as an SSD and an HDD, and has a log information storage part 431, a degradation map storage part 432, and a delivery schedule storage part 433.

The log information storage part 431 stores log information about the mobile vehicle log transmitted from the mobile vehicle 300 and the charge log transmitted from the charge control device 100.

The degradation map storage part 432 stores a degradation map of the battery 340. The degradation map includes a storage degradation map and a charge degradation map. The storage degradation map shows a relation between a plurality of states of the battery 340 (e.g., the temperature and the SOC of the battery 340) and a degradation speed in storage in accordance with each state. The storage degradation map represents a degradation map about a state where the battery 340 is neither charged nor discharged, i.e., about a storage state. The charge degradation map shows a relation between a plurality of states (e.g., the charging electric current and the SOC) of the battery 340 and a degradation speed in charging in accordance with each state. The degradation map is prepared for each type (e.g., model) of the battery 340.

The delivery schedule storage part 433 stores a delivery schedule for each of the mobile vehicles 300. The delivery schedule represents a delivery schedule in a predetermined period (e.g., one day) for each mobile vehicle 300. Specifically, the delivery schedule includes information about one or more articles to be delivered by each mobile vehicle 300. The information about each article includes an identifier of the article, a delivery destination of the article, a dispatch place of the article, and a weight of the article. The delivery schedule is generated for each mobile vehicle 300 located at the collection and delivery station.

The processor 420 has a data management part 421, a charging schedule generation part 422, and a delivery schedule generation part 423. Each of the data management part 421 to the delivery schedule generation part 423 comes into effect when the processor 420 executes a program for causing the computer to serve as the server 400.

The data management part 421 causes the log information storage part 431 to store the mobile vehicle log received by the communication part 410. The data management part 421 causes the log information storage part 431 to store the charge log received by the communication part 410.

The charging schedule generation part 422 generates a charging schedule for each of the mobile vehicles 300 on the basis of the battery information D71 transmitted from each mobile vehicle 300, the pseudo-charger information D82 transmitted from the charge control device 100, the degradation map of the battery 340 of each mobile vehicle 300, and the delivery schedule for each mobile vehicle 300.

For instance, the charging schedule generation part 422 calculates a travel distance of the mobile vehicle 300 on a delivery day from the delivery schedule, calculates, on the basis of the calculated travel distance and a weight of an article to be delivered, a necessary charge amount for the mobile vehicle 300 on the delivery day, and calculates a target charge amount from the calculated necessary charge amount and the remaining charge amount of the battery 340. Moreover, the charging schedule generation part 422 specifies a degradation map for the battery 340 from a battery type included in the battery information D71. Furthermore, the charging schedule generation part 422 calculates a charging schedule for charging the battery 340 to reach the target charge amount and suppressing degradation of the battery 340 by using: the specified degradation map; the various kinds of information included in the battery information D71; and the various kinds of information included in the pseudo-charger information D82.

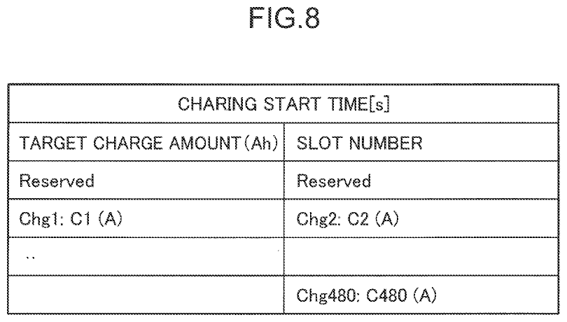

FIG. 8 shows an example of a data configuration of the charging schedule. The charging schedule includes a charging start time, a target charge amount, and an electric current instructive value. The charging start time represents a time when charging is started. The target charge amount represents a target value of a charge amount to be supplied to the battery 340 at this stage. The electric current instructive value represents an electric current instructive value per time unit. In the example shown in FIG. 8, an electric current instructive value is described for each of M-slots from the first to the M-th ones, where “M” is an integer equal to or greater than 2. The electric current instructive values described in the first slot to the M-th slot are sequentially read out per time unit to charge the mobile vehicle 300. Each electric current instructive value is set to such a value as to suppress degradation of the battery 340 depending on the state thereof.

Next, a process of generating the pseudo-battery information D72 from the battery information D71 will be described with reference to FIG. 6. FIG. 6 shows an example of a data configuration of each of the battery information D71 and the pseudo-battery information D72.

The data generation section 151 specifies a common protocol version which enables communication with the charger 200 for all the protocol versions of the mobile vehicles 300 to be charged, and set the specified common protocol version to a protocol version in the pseudo-battery information D72. When failing to specify the common protocol version, the data generation section 151 sets the protocol version in the pseudo-battery information D72 to “Not Applicable”.

When the battery type included in the battery information D71 shows matching, the data generation section 151 sets the battery type included in the pseudo-battery information D72 to the matched battery type. Contrarily, when the battery type in the battery information D71 shows mismatching, the data generation section 151 sets the battery type in the pseudo-battery information D72 to “Not Applicable”.

The data generation section 151 sets a total value of rated capacities of the mobile vehicles 300 to be charged as a rated capacity in the pseudo-battery information D72.

The data generation section 151 sets a maximum value of total rated voltages of the mobile vehicles 300 to be charged as a total rated voltage in the pseudo-battery information D72.

The data generation section 151 sets a minimum value of single battery maximum allowable charging voltages of the mobile vehicles 300 to be charged as a single battery maximum allowable charging voltage in the pseudo-battery information D72.

The data generation section 151 sets a total value of maximum allowable charging electric currents of the mobile vehicles 300 to be charged as a maximum allowable charging electric current in the pseudo-battery information D72.

The data generation section 151 sets a total value of rated energy amounts of the mobile vehicles 300 to be charged as a rated energy amount in the pseudo-battery information D72.

The data generation section 151 sets a minimum value of maximum allowable total charging voltages of the mobile vehicles 300 to be charged as a maximum allowable total charging voltage in the pseudo-battery information D72.

The data generation section 151 sets a minimum value of maximum allowable temperatures of the mobile vehicles 300 to be charged as a maximum allowable temperature in the pseudo-battery information D72.

The data generation section 151 sets an average value or a maximum value of the SOCs of the mobile vehicles 300 to be charged as an SOC in the pseudo-battery information D72.

The data generation section 151 sets an average value or a maximum value of current voltages of the mobile vehicles 300 to be charged as a current voltage in the pseudo-battery information D72.

When each of the mobile vehicles 300 to be charged is in the charge standby state, the data generation section 151 sets a charge standby state in the pseudo-battery information D72 to “OK”, i.e., applicable. Contrarily, when one of the mobile vehicles 300 is not in the charge standby state, the data generation section 151 sets the charge standby state in the pseudo-battery information D72 to “Not Applicable”.

In the above-described manner, the battery information D71 about the plurality of mobile vehicles is collected to generate the pseudo-battery information D72 for the single charger 200.

Next, a process of generating the pseudo-charger information D82 from the charger information D81 will be described with reference to FIG. 7. FIG. 7 shows an example of a data configuration of each of the charger information D81 and the pseudo-charger information D82.

The data generation section 151 sets a value of each of a maximum output voltage, a minimum output voltage, a minimum output electric current, and a charge standby state in the pseudo-charger information D82 to each corresponding value as it is in the charger information D81. The data generation section 151 sets a value obtained by multiplying the maximum output electric current in the charger information D81 by a distribution factor of a corresponding mobile vehicle 300 as a maximum output electric current in the pseudo-charger information D82. The distribution factor is calculated by “a rated energy amount of the corresponding mobile vehicle 300/a total value of rated energy amounts of the mobile vehicles 300 to be charged”. However, this is a mere example. The distribution factor may be calculated by “1/the number of mobile vehicles 300 to be charged”.

As described heretofore, regarding the pseudo-charger information D82, the maximum output electric current which the charger 200 can output is distributed at the distribution factor to calculate the pseudo-charger information D82 individually for each of the mobile vehicle 300. Consequently, the electric current from the charger 200 is distributable to the mobile vehicles 300 respectively.

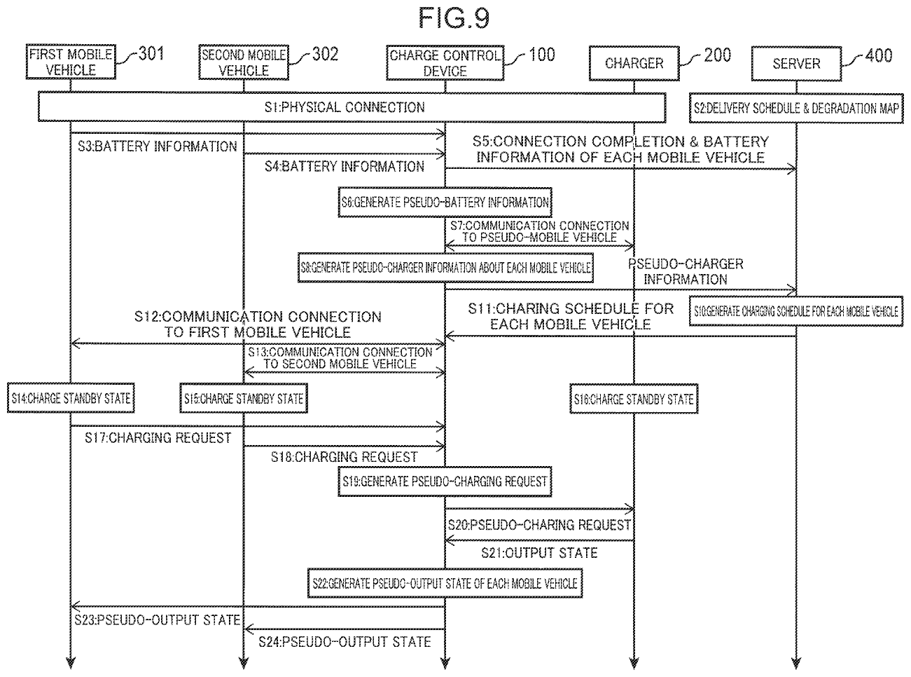

FIG. 9 is a sequence diagram showing an example of a process by the charging system 1 shown in FIG. 1. The sequence diagram shows two mobile vehicles 300, i.e., a first mobile vehicle 301 and a second mobile vehicle 302, to be charged.

In step S1, the first mobile vehicle 301, the second mobile vehicle 302, the charge control device 100, and the charger 200 are physically connected to one another. Specifically, a connected part 310 of the first mobile vehicle 301 is connected to a corresponding first connection part 110, a connected part 310 of the second mobile vehicle 302 is connected to another corresponding first connection part 110, and the charging connector 210 of the charger 200 is connected to the second connection part 130 of the charge control device 100.

In step S2, the server 400 acquires a delivery schedule and a degradation map. Specifically, the server 400 acquires the delivery schedule and the degradation map by receiving the schedule and the map from the terminal device 500. The degradation map corresponds to a type of the battery 340 of each of the first mobile vehicle 301 and the second mobile vehicle 302.

In step S3, the first mobile vehicle 301 transmits battery information D71 thereabout to the charge control device 100. In step S4, the second mobile vehicle 302 transmits battery information D71 thereabout to the charge control device 100.

In step S5, the charge control device 100 transmits, to the server 400 via the second communication section 142, connection completion indicating completion of the physical connection among the first mobile vehicle 301, the second mobile vehicle 302, and the charger 200, and further the battery information D71 about each of the first mobile vehicle 301 and the second mobile vehicle 302.

In step S6, the data generation section 151 of the charge control device 100 generates pseudo-battery information D72 from the received battery information D71 by employing the aforementioned way. In step S7, the first communication section 141 of the charge control device 100 establishes a communication connection with the charger 200 by transmitting the pseudo-battery information D72 to the charger 200 and receiving a response to the pseudo-battery information D72 from the charger 200. In this manner, the communication connection is established between the charger 200 and a single pseudo-mobile vehicle imitating the first mobile vehicle 301 and the second mobile vehicle 302. Here, the response transmitted from the charger 200 includes the charger information D81.

In step S8, the data generation section 151 of the charge control device 100 generates pseudo-charger information D82 from the charger information D81 for each of the first mobile vehicle 301 and the second mobile vehicle 302 by employing the aforementioned way.

In step S9, the data generation section 151 of the charge control device 100 transmits the generated pseudo-charger information D82 to the server 400 via the second communication section 142.

In step S10, the charging schedule generation part 422 of the server 400 generates a charging schedule for each of the first mobile vehicle 301 and the second mobile vehicle 302, on the basis of the battery information D71 about each mobile vehicle 300 as received in step S5, the pseudo-charger information D82 about each mobile vehicle 300 as received in step S9, and the delivery schedule and the delivery map acquired in step S2.

In step S11, the charging schedule generation part 422 of the server 400 transmits the generated charging schedule to the charge control device 100 via the communication part 410.

In step S12, the first communication section 141 of the charge control device 100 establishes a communication connection between the first mobile vehicle 301 and the charge control device 100 by transmitting the pseudo-charger information D82 about the first mobile vehicle 301 as generated in step S8 to the first mobile vehicle 301 and receiving a response to the pseudo-charger information D82 from the first mobile vehicle 301.

In step S13, the first communication section 141 of the charge control device 100 establishes a communication connection between the second mobile vehicle 302 and the charge control device 100 by transmitting the pseudo-charger information D82 about the second mobile vehicle 302 as generated in step S8 to the second mobile vehicle 302 and receiving a response to the pseudo-charger information D82 from the second mobile vehicle 302.

In step S14, the first mobile vehicle 301 enters a charge standby state. In step S15, the second mobile vehicle 302 enters a charge standby state. In step S16, the charger 200 enters a charge standby state.

Steps S1 to S16 described above form the communication establishment phase in the process. Subsequently, the charging phase is started.

In step S17, the first mobile vehicle 301 transmits a charging request to the charge control device 100. In step S18, the second mobile vehicle 302 transmits a charging request to the charge control device 100.

In step S19, the data generation section 151 of the charge control device 100 generates a pseudo-charging request concerning the single charger 200 on the basis of the charging requests received in step S17 and step S18 and the charging schedule for each of the first mobile vehicle 301 and the second mobile vehicle 302 as received in step S11.

For instance, the charging request from the first mobile vehicle 301 is defined as “A1” and the charging request from the second mobile vehicle 302 is defined as “A2”. A charging request electric current is defined as “H”. Besides, a charging request electric current included in the charging request A2 is defined as “I2”. In this case, the data generation section 151 may set a total value of the charging request electric current I1 and the charging request electric current I2 to a charging request electric current I3. Here, when the charging request electric current I1 is larger than an electric current instructive value IP1 designated in the charging schedule for the first mobile vehicle 301, the data generation section 151 may calculate the charging request electric current I3 by using the electric current instructive value IP1 in place of the charging request electric current H. Similarly, when the charging request electric current I2 is larger than an electric current instructive value IP2 designated in the charging schedule for the second mobile vehicle 302, the data generation section 151 may calculate the charging request electric current I3 by using the electric current instructive value IP2 in place of the charging request electric current I2.

In step S20, the first communication section 141 of the charge control device 100 transmits the pseudo-charging request to the charger 200. In step S21, the charger 200 transmits an output state. The charger 200 having received the pseudo-charging request outputs, to the charge control device 100, an electric current representing the charging request electric current included in the pseudo-pseudo-charging request. Hence, in the output state, the value of the charging request electric current is set as an output electric current.

In step S22, the data generation section 151 of the charge control device 100 generates a pseudo-output state for each of the first mobile vehicle 301 and the second mobile vehicle 302 by distributing the output state received in step S21 to each of the first mobile vehicle 301 and the second mobile vehicle 302.

For instance, an output electric current included in the output state of the charger 200 is defined as “IO”, and an output voltage included therein is defined as “VO”. Besides, the pseudo-output state for the first mobile vehicle 301 is defined as “ST1”, and the pseudo-output state for the second mobile vehicle 302 is defined as “ST2”. Furthermore, a pseudo-output electric current in the pseudo-output state ST1 is defined as “IO_1”, a pseudo-output voltage in the pseudo-output state ST1 is defined as “VO_1”, a pseudo-output electric current in the pseudo-output state ST2 is defined as “IO_2”, and a pseudo-output voltage in the pseudo-output state ST2 is defined as “VO_2”.

In this case, the data generation section 151 may calculate the pseudo-output electric current IO_1 by “IO×the distribution factor”. Regarding the distribution factor, for example, the way “a rated energy amount of the first mobile vehicle 301/a total value of rated energy amounts of the first mobile vehicle 301 and the second mobile vehicle 302” may be adopted, or “1/the number of mobile vehicles 300 to be charged=2” may be adopted, as described above.

Similarly, the data generation section 151 may calculate the pseudo-output electric current IO_2 by “IO×the distribution factor”. In this case, regarding the distribution factor, for example, the way “a rated energy amount of the second mobile vehicle 302/the total value of rated energy amounts of the first mobile vehicle 301 and the second mobile vehicle 302” may be adopted, or “1/the number of mobile vehicles 300 to be charged=2” may be adopted. Here, when the pseudo-output electric current IO_1 is larger than the electric current instructive value P1 designated in the charging schedule for the first mobile vehicle 301, the data generation section 151 may set the electric current instructive value IP1 to the pseudo-output electric current IO_1. Further, when the pseudo-output electric current IO_2 is larger than the electric current instructive value IP2 designated in the charging schedule for the second mobile vehicle 302, the data generation section 151 may set the electric current instructive value IP2 to the pseudo-output electric current IO_2.

Additionally, the data generation section 151 may set the output voltage VO to each of the pseudo-output voltage VO_1 and to the pseudo-output voltage VO_2.

In step S23, the first communication section 141 of the charge control device 100 transmits the pseudo-output state ST1 to the first mobile vehicle 301. In step S24, the first communication section 141 of the charge control device 100 transmits the pseudo-output state ST2 to the second mobile vehicle 302.

Thereafter, the charge control section 152 of the charge control device 100 controls the distributer 170 to divide the output electric current IO supplied from the charger 200 to the pseudo-output electric current IO_1 and the pseudo-output electric current IO_2. Consequently, the pseudo-output electric current IO_1 is supplied to the first mobile vehicle 301, and the pseudo-output electric current IO_2 is supplied to the second mobile vehicle 302.

Conclusively, as described heretofore, according to the embodiment, the charge control device 100 includes the plurality of first connection parts 110 respectively connectable to the plurality of mobile vehicles 300, and the second connection part 130 connectable to the single charger 200. The charge control device 100 having this configuration achieves a physical connection between the single charger 200 and the mobile vehicles 300.

Moreover, the charge control device 100 generates a piece of pseudo-battery information D72 (a fourth datum) from the battery information D71 (first data) transmitted from the mobile vehicles 300 respectively and transmits the generated piece of pseudo-battery information to the charger 200, and further generates pseudo-charger information D82 (second data) for the mobile vehicles 300 respectively from the charger information D81 (a third datum) received from the charger 200 in response to the piece of pseudo-battery information D72 and transmits the generated pseudo-charger information to the mobile vehicles 300 respectively. Here, each of the battery information D71, the pseudo-battery information D72, the charger information D81, and the pseudo-charger information D82 complies with a predetermined charging standard. This configuration permits the charger 200 to communicate with the mobile vehicles 300 without changing the charging standard.

In addition, in the case of N=1, that is, in the case of a single mobile vehicle 300, the charge control device 100 for controlling communication to perform charging in a pseudo-manner is arranged between the mobile vehicle 300 and the charger 200. This arrangement enables a charge control in accordance with the charging schedule without changing the configuration of each mobile vehicle 300 and the charger 200.

### Second Embodiment

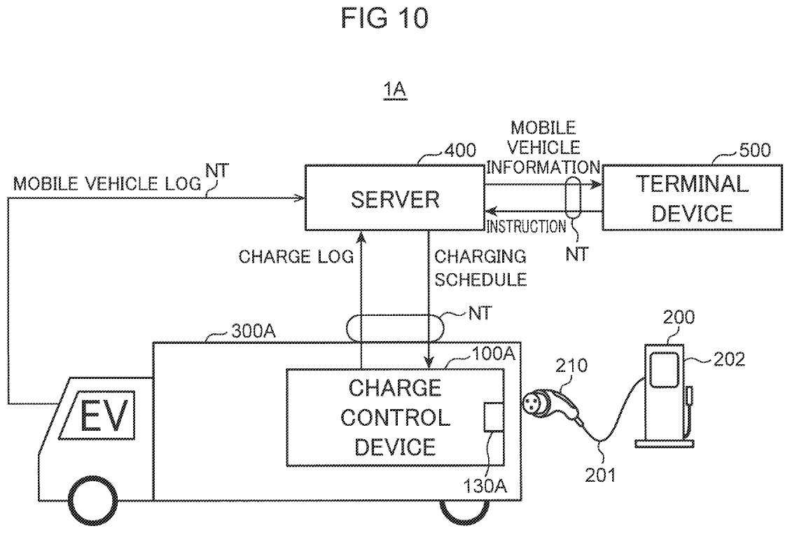

FIG. 10 shows an overall configuration of a charging system 1A in a second embodiment of the disclosure. In the embodiment, a charge control device 100A is provided in a mobile vehicle 300A. Here, description for substantially the same configuration as that in the first embodiment will be omitted.

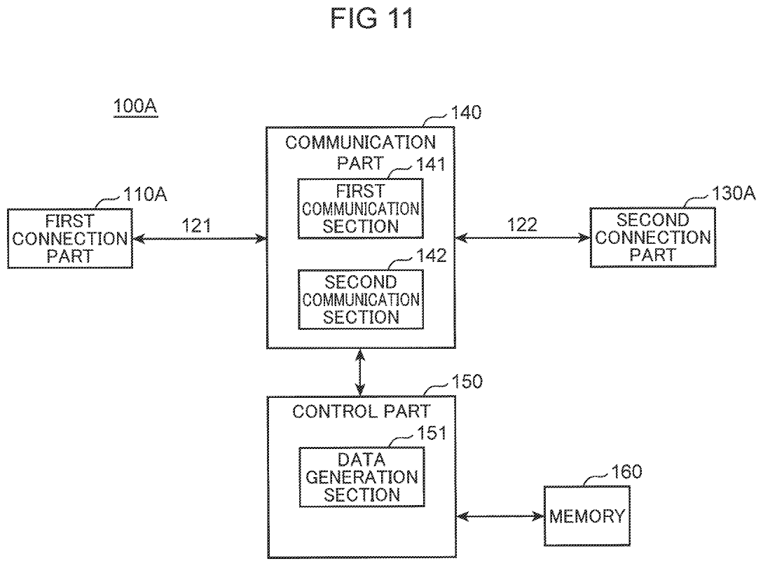

Next, the charging system 1A will be described in detail. FIG. 11 is a block diagram showing a configuration of the charge control device 100A shown in FIG. 10. The charge control device 100A includes a first connection part 110A, a second connection part 130A, a communication part 140, a control part 150, and a memory 160.

The first connection part 110A has a communication terminal. The communication terminal allows the charge control device 100A to communicate with a communication part 320.

The second connection part 130A has a communication terminal. The communication terminal allows the charge control device 100A to communicate with a charger 200 via a connected part 310A of the mobile vehicle 300A.

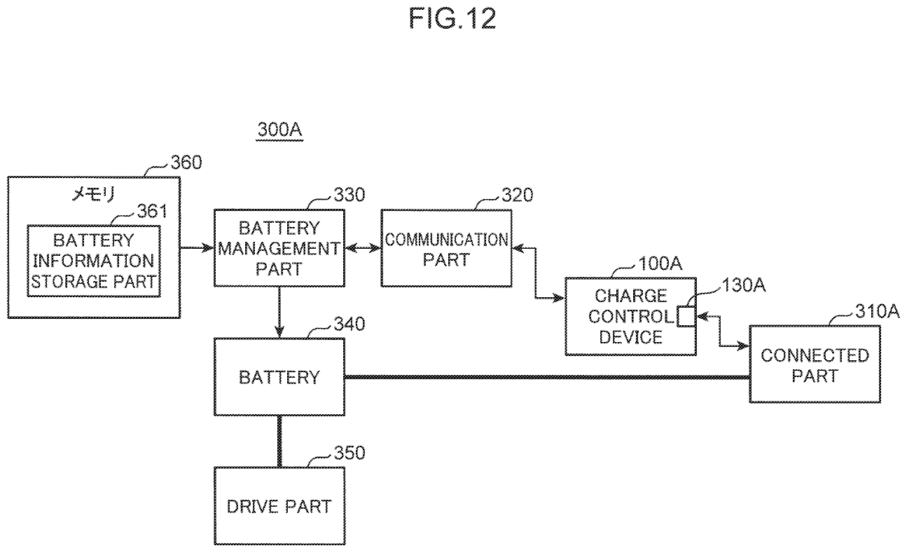

FIG. 12 is a block diagram showing a configuration of the mobile vehicle 300A shown in FIG. 10. The mobile vehicle 300A includes the charge control device 100A, in addition to the connected part 310A, the communication part 320, a battery management part 330, a battery 340, a drive part 350, and a memory 360.

The connected part 310A is connectable to the charger 200. The connected part 310A is connected to the second connection part 130A of the charge control device 100A via a communication line. The connected part 310A is connected to the battery 340 via an electric power line.

Here, a process by the charging system 1A is substantially the same as the process in the first embodiment, and thus description therefor is omitted.

Conclusively, as described heretofore, according to the embodiment, the charge control device 100A is provided in the mobile vehicle 300A, and the charge control device 100A can control the charging to the battery 340 mounted on the mobile vehicle 300A in accordance with a charging schedule received from a server 400. In addition, arrangement of the charge control device 100A configured to control communication for charging in a pseudo-manner between the connected part 310A and the communication part 320 enables a charge control in accordance with the charging schedule without changing the configuration of the mobile vehicle 300A.

This disclosure can adopt modifications described below.

(1) Although the single charger 200 is shown in FIG. 1, this is a mere example. The charging system 1 may include a plurality of chargers 200. In this case, the chargers 200 are connectable to a plurality of mobile vehicles 300 respectively.

(2) The charge control device 100 includes the single second connection part 130 in FIG. 1, but may include a plurality of second connection parts 130. In this case, a plurality of chargers 200 is connectable to the plurality of second connection parts 130 to enable charging to a plurality of mobile vehicles 300 respectively connected to a plurality of first connection parts 110. Here, the number of first connection parts 110 may be defined to be larger than the number of second connection parts 130, i.e., the number of mobile vehicles 300 may be defined to be larger than the number of chargers 200.

(3) Although the charge control device 100 includes the data generation section 151 in FIG. 2, this is a mere example. A server 400 may include a data generation section. In this case, the server 400 executes the process of generating a fourth datum from first data, generating second data for a plurality of mobile vehicles 300 respectively from a third datum received from the charger 200 in response to the fourth datum, and causing a first communication section 141 to transmit the fourth datum and the second data.

(4) A charge control device 100 may collate a charging schedule and a charge log for a certain mobile vehicle 300, and transmit, when it is determined that charging is inexecutable in accordance the charging schedule, the determination result to a server 400. In this case, the server 400 may determine whether to continue the charging to the mobile vehicle 300 or to change the charging schedule for the mobile vehicle 300. The server 400 further may transmit, to the charge control device 100, an instruction of stopping the charging to the mobile vehicle 300 when determining to change the charging schedule.

### INDUSTRIAL APPLICABILITY

According to this disclosure, a plurality of mobile vehicles is chargeable by employing an already-existing charger, and therefore, this disclosure is useful for a charging system to charge an electrically driven mobile vehicle.

1. A charge control device, comprising:
a plurality of first connection parts respectively connectable to a plurality of mobile vehicles each having a battery;
a second connection part connectable to a charger; and
a first communication section configured to:
(1) receive first data from the mobile vehicles respectively and transmit second data to the mobile vehicles respectively via the first connection parts; and
(2) receive a third datum from the charger and transmit a fourth datum to the charger via the second connection part, each of the first data, the second data, the third datum, and the fourth datum complying with a charging standard; and
a control part that generates the fourth datum from the first data, generates the second data for the mobile vehicles respectively from the third datum received from the charger in response to the fourth datum, and causes the first communication section to transmit the fourth datum and the second data.

2. The charge control device according to claim 1, further comprising a second communication section that transmits the first data to an external device and receives a charging schedule for each of the mobile vehicles from the external device, wherein
charging to each of the mobile vehicles is controlled in accordance with the charging schedule.

3. The charge control device according to claim 2, wherein each of the first data and the fourth datum includes a state of the battery,
each of the second data and the third datum includes an output way of the charger,
the state of the battery included in the fourth datum is generated by calculation of or comparison with the state of the battery included in each of the first data, and
each output way included in the second data is generated by distributing the output way included in the third datum to each of the mobile vehicles.

4. The charge control device according to claim 3, wherein each of the first data and the fourth datum further includes a specification of the battery of each of the mobile vehicles,
the second communication section further transmits, to the external device, the specification and the state of the battery of each of the mobile vehicles, and a plurality of generated output ways of the charger as a plurality of pseudo-output ways, and
the received charging schedule is based on the transmitted specification and state of the battery of each of the mobile vehicles, and based on the generated pseudo-output ways of the charger.

5. The charge control device according to claim 1, further comprising a second communication section that receives a charging schedule for each of the mobile vehicles from an external device, wherein
the fourth datum is generated from the first data in accordance with the charging schedule.

6. The charge control device according to claim 5, wherein each of the first data and the fourth datum includes a charging request,
each of the second data and the third datum includes an output state of the charger,
the charging request included in the fourth datum is generated on the basis of at least one of the charging request included in the first data and the charging schedule for each of the mobile vehicles to be charged at the same time in accordance with the charging schedule, and
each output state included in the second data is generated by distributing the output state included in the third datum to each of the mobile vehicles.

7. The charge control device according to claim 6, wherein an electric current output from the charger in accordance with each output state included in the second output data is distributed to each of the mobile vehicles.

8. An information processing method for a charge control device for charging a plurality of mobile vehicles each having a battery, the charge control device including: a plurality of first connection parts respectively connectable to the mobile vehicles; and a second connection part connectable to a charger, the method comprising, by a computer:
receiving first data from the mobile vehicles respectively via the first connection parts;
generating a fourth datum from the first data;
transmitting the fourth datum to the charger via the second connection part;
receiving a third datum from the charger in response to the fourth datum;
generating second data for the mobile vehicles respectively from the third datum; and
transmitting the second data to the charger via the first connection parts, each of the first data, the second data, the third datum, and the fourth datum complying with a charging standard.

9. A charge control device, comprising:
a first connection part connectable to a mobile vehicle having a battery;
a second connection part connectable to a charger;
a first communication section configured to:
(1) receive a first datum from the mobile vehicle and transmit a second datum to the mobile vehicle via the first connection part; and
(2) receive a third datum from the charger and transmit a fourth datum to the charger via the second connection part, each of the first datum, the second datum, the third datum, and the fourth datum complying with a charging standard; and
a control part that generates the fourth datum from the first datum, generates the second datum for the mobile vehicle from the third datum received from the charger in response to the fourth datum, and causes the first communication section to transmit the fourth datum and the second datum.

10. The charge control device according to claim 9, further comprising a second communication section that receives a charging schedule for the mobile vehicle from an external device, wherein
the fourth datum is generated from the first datum to in accordance with the charging schedule.

11. The charge control device according to claim 10, wherein each of the first datum and the fourth datum includes a charging request,
each of the second datum and the third datum includes an output state of the charger,
the charging request included in the fourth datum is generated on the basis of at least one of the charging request included in the first datum and the charging schedule for the mobile vehicle, and
the output state included in the second datum is generated from the output state included in the third datum.

12. The charge control device according to claim 11, wherein an electric current output from the charger is supplied to the mobile vehicle in accordance with the output state included in the second datum.

13. An information processing method for a charge control device for charging a mobile vehicle having a battery, the charge control device including: a first connection part connectable to the mobile vehicle and a second connection part connectable to a charger, the method comprising, by a computer:
receiving a first datum from the mobile vehicle via the first connection part;
generating a fourth datum from the first datum;
transmitting the fourth datum to the charger via the second connection part;
receiving a third datum from the charger in response to the fourth datum;
generating a second datum for the mobile vehicle from the third datum; and
transmitting the second datum to the charger via the first connection part, each of the first datum, the second datum, the third datum, and the fourth datum complying with a charging standard.
